(19) United States
(12) Patent Application Publication
(10) Pub. No.: US 2016/0092635 A1
(43) Pub. Date: Mar. 31, 2016

(54) APPARATUS AND METHOD FOR SUPPORTING MEDICAL EXAMINATION BASED ON PERSONALIZED CHECKLIST

(71) Applicant: SAMSUNG ELECTRONICS CO., LTD., Suwon-si (KR)

(72) Inventor: Ha Young KIM, Yongin-si (KR)

(73) Assignee: SAMSUNG ELECTRONICS CO., LTD., Suwon-si (KR)

(21) Appl. No.: 14/862,383

(22) Filed: Sep. 23, 2015

(30) Foreign Application Priority Data
Sep. 26, 2014 (KR) 10-2014-0129560

(51) Int. Cl. G06F 19/00

(52) U.S. Cl. CPC G06F 19/322; G06F 19/363

(57) ABSTRACT

An apparatus and method for supporting a medical examination based on a personalized checklist. The apparatus includes a checklist generator to generate a personalized checklist based on a patient's medical information; and an item performance confirmer to determine whether each item included in the checklist is performed by analyzing a medical examination process of the patient.

### CROSS-REFERENCE TO RELATED APPLICATION(S)

This application claims the benefit under 35 U.S.C. §119(a) of Korean Patent Application No. 10-2014-0129560, filed on Sep. 26, 2014, in the Korean Intellectual Property Office, the entire disclosure of which is incorporated herein by reference for all purposes.

### BACKGROUND

1. Field

The following description relates to an apparatus and method for supporting a medical examination based on a personalized checklist.

2. Description of Related Art

A medical team may check previously acquired examination records and information by asking a patient about one's condition. The medical team may then determine which areas or specific locations on the patient are to be checked and considered more carefully during an ultrasound examination. Armed with this pre-evaluation diagnosis, the medical team may start an medical examination of the patient.

During an ultrasound examination, the medical team may perform a check of a region that should be examined and not missed and a region where a patient complains of pain. Moreover, if there was an unusual region, such as microcalcifications, etc., the medial team may check a region where the microcalcifications appeared on a past ultrasound record. Thereafter, medical team may then save the required videos and may finish the ultrasound examination. However, because of a degree of fatigue and other such states of the medical team, there are cases in which the medical team may not check a position or a region which should have been checked with a probe. Indeed, by carelessness or mistake, the medical examination may finish the ultrasound examination without saving videos that are required for the follow-up examinations or for description to a patient.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, there is provided an apparatus for supporting a medical examination that includes a checklist generator configured to generate a personalized checklist based on medical information, and an item performance confirmer configured to determine whether each item included in the checklist is performed, by analyzing a medical examination process.

The checklist may include items to be performed or checked, and considerations for medical examination.

The medical information may include at least one of medical examination information by interview and a past examination record.

The checklist generator may include a first checklist generator configured to generate a first checklist by analyzing the medical information, a second checklist generator configured to generate a second checklist according to an input, and a checklist combiner configured to combine the first checklist and the second checklist.

The apparatus may further include an input configured to receive an input of the medical information in at least one form of a text, a voice, and a video.

The checklist generator may be configured to generate the checklist by using at least one of a text mining technique, a voice recognizing technique, and a video recognizing technique according to the input medical information.

The item performance confirmer may be configured to analyze a medical examination process based on at least one of position information of a probe used in a medical examination, scanned information of the probe, voice information, video information acquired by wearable devices, and behavior information acquired by an external camera, and determine whether each of the items included in the checklist is performed.

The apparatus may further include a checklist modifier configured to modify the checklist generated according to an input.

The apparatus may further include a display configured to output the generated checklist to a screen, wherein the display is configured to, according to the determination result of the item performance confirmer, display items of completed performance to be distinguished from items of uncompleted performance.

The display may be configured to display the items of completed performance to be distinguished from the items of uncompleted performance by marking the items of completed performance, changing a color or transparency of the items of completed performance, or deleting the items of completed performance from a list.

In another aspect, there is provided a method of supporting a medical examination that includes generating a personalized checklist based on medical information, and determining whether each item included in the checklist is performed, by analyzing a medical examination process.

The checklist may include items to be performed or checked, and considerations for medical examination.

The medical information may include at least one of medical examination information by interview and a past examination record.

The generating of the checklist may include generating a first checklist by analyzing the medical information, generating a second checklist according to an input, and combining the first checklist and the second checklist.

The method may further include receiving an input of the medical information in at least one form of a text, a voice, and a video.

The generating of the checklist may include generating the checklist by using at least one of a text mining technique, a voice recognizing technique, and a video recognizing technique according to the input medical information.

The determining of whether each of the items included in the checklist is performed may include analyzing a medical examination process based on at least one of position information of a probe used in a medical examination, scanned information of the probe, voice information, video information acquired by wearable devices, and behavior information acquired by an external camera, and determining whether each of the items included in the checklist is performed.

The method may further include modifying the checklist generated according to an input.

The method may further include displaying items of completed performance to be distinguished from items of uncompleted performance, according to the determination result of the determining of whether each of the items included in the checklist is performed.

The displaying of the items of completed performance to be distinguished from the items of uncompleted performance may include displaying the items of completed performance to be distinguished from the items of uncompleted performance by marking the items of completed performance, changing a color or transparency of the items of completed performance, or deleting the items of completed performance from a list.

There is also provided a non-transitory computer-readable medium storing program instructions for controlling a processor to perform the method of supporting a medical examination.

Still further, there is provided an apparatus for supporting a medical examination that includes a checklist generator configured to generate a personalized checklist based on medical information, and an item performance confirmer configured to confirm each item included in the checklist is performed.

The checklist generator may include a first checklist generator configured to generate a first checklist, a second checklist generator configured to generate a second checklist, and a checklist combiner configured to combine the first checklist and the second checklist.

The checklist combiner may be configured to combine the first checklist and the second checklist is based on a preset preference or a preset condition.

Other features and aspects will be apparent from the following detailed description, the drawings, and the claims.

### BRIEF DESCRIPTION OF THE DRAWINGS

FIG. 1 is a diagram illustrating an apparatus for supporting a medical examination according to an aspect.

FIG. 2 is a diagram illustrating an apparatus for supporting a medical examination according to another aspect.

FIG. 3A is a diagram illustrating an aspect of a first checklist.

FIG. 3B is a diagram illustrating an aspect of a second checklist.

FIG. 3C is a diagram illustrating an aspect of a combined checklist.

FIG. 4A is a diagram illustrating an aspect of marking items of completed performance.

FIG. 4B is a diagram illustrating an aspect of changing colors of items of completed performance.

FIG. 4C is a diagram illustrating an aspect of deleting items of completed performance from a list.

FIG. 5 is a flowchart illustrating a method of supporting a medical examination according to an aspect.

FIG. 6 is a detailed flowchart illustrating an operation of generating a personalized checklist of FIG. 5.

FIG. 7 is a flowchart illustrating a method of supporting a medical examination according to another aspect.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. However, after an understanding of the present disclosure, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that may be well known to one of ordinary skill in the art may be omitted for increased clarity and conciseness.

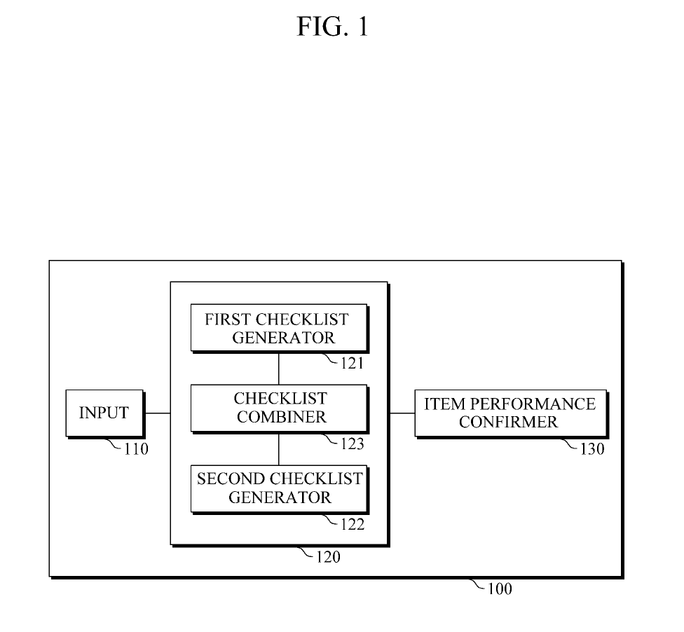

FIG. 1 is a diagram illustrating an apparatus for supporting a medical examination according to an aspect.

In an aspect, an apparatus 100 for supporting a medical examination may be installed on an ultrasonic diagnostic equipment. The apparatus 100 may generate a personalized checklist that includes various items, which are to be performed during an ultrasound examination, and may provide the checklist to a user. The apparatus 100 may also automatically determine whether each of the items included in the checklist is to be performed, and may provide the result to the user. This procedure may be useful in reducing mistakes committed by the user's mistakes during a medical examination of a patient.

Referring to FIG. 1, the apparatus 100 may include an input 110, a checklist generator 120, and an item performance confirmer 130. The checklist generator 120 may also include a first checklist generator 121, a second checklist generator 122, and a checklist combiner 123.

The input 110 may receive an input of medical information of the patient to be examined. In particular, the input 110 may receive the patient's medical information in various forms, such as a text, a voice, and a video, among others.

The medical information is information on the patient who may be referred to during the medical examination, and may include medical examination information by interview. Information obtained by interview may be acquired by asking the patient about one's condition, past examination results, medical history, and other such information.

The medical examination information by interview may be acquired by asking the patient about one's condition, and may include information on a location of pain, a location of a touchable lump, the patient's age, whether the patient has dense breasts, family history, history of any surgeries, and history and current status of any diseases, and other such information.

A past examination record may include various medical examination records of the patient, which have been performed in the past, and may include an X-ray examination record, a Breast Mammography examination record, an ultrasound examination record, a computed tomography (CT) examination record, a Magnetic Resonance Imaging (MRI) examination record, and a Positron Emission Tomography (PET) examination record, for example.

The checklist generator 120 may generate a personalized checklist based on inputted medical information of the patient. Here, the checklist may include items to be performed or checked in consideration of the medical examination. To this end, the checklist generator 120 may include the first checklist generator 121, the second checklist generator 122, and the checklist combiner 123 to facilitate in generating the personalized checklist.

The first checklist generator 121 may analyze the patient's medical information input by the input 110 and generate a first checklist.

In an aspect, the first checklist generator 121 may generate the first checklist by using a text mining technique, a voice recognizing technique, and a video recognizing technique, or other similar techniques. Text mining is the analysis of data contained in natural language text in which words and phrases in unconstructed data are transposed into numerical values which can then be linked with structured data in a database. Voice recognition is the identification of a person from characteristics of voice biometrics which is a numerical representation of the sound, pattern, and rhythm of an individual's voice. Video recognition is the identification of a person from characteristics video or object biometrics which is a numerical representation of the size, shape, and pattern of an individual's body part.

For example, the user may acquire information on a painful region of the patient during a medical examination interview. Specifically, the patient may indicate that there is a pain in a region located at a distance of 2 cm from a nipple on a left breast at a 3 o'clock direction during the interview. In such a case, if the acquired information on a painful region is input such as a text, a voice, and a video, for example, by the input 110, the first checklist generator 121 may generate an item, of a checklist, that may communicate “checking a painful region at a distance of 2 cm from a nipple on a left breast at a 3 o'clock direction”, based on the input information on a painful region. In other words, the first checklist generator 121 may generate the item for the checklist that conveys that a painful region exists a distance of 2 cm from a nipple on a left breast at a 3 o'clock direction according to the inputted interview information inputted by input 110 which is based on the medical examination interview of the patient.

In another aspect, the first checklist generator 121 may generate an item of the first checklist based on the patient's previous ultrasound examination record in which the ultrasound examination record indicates that a fibrodenoma was detected on a region located at a distance of 3 cm from a nipple on a left breast at a 9 o'clock direction. In this case, if the previous ultrasound examination record is input by the input 110 as a text, a voice, and a video, for example, the first checklist generator 121 may generate, based on the input of the previous ultrasound examination record, the item of the first checklist, which is “tracking and monitoring a tumor at a distance of 3 cm from a nipple on a left breast at a 9 o'clock direction”. In other words, the first checklist generator 121 may generate the item of the first checklist that conveys that a fibrodenoma was detected on a region located at a distance of 3 cm from a nipple on a left breast at a 9 o'clock direction according to the previous ultrasound examination record inputted by input 110.

In another aspect, the first checklist generator 121 may generate items of the checklist, which are “saving an ultrasound image when tracking and monitoring” and “checking a tumor size”. The generations of these specific items on the checklist may be generated as needed or may be generated in each instance in which the first checklist generator 121 generates the first checklist.

In another aspect, the user may acquire medical information of the patient that indicates that a lump is sensed around an armpit near a left breast by asking the patient about one's condition. In this case, if the acquired medical information is input by the Input 110 as a text, a voice, and a video, for example, the first checklist generator 121 may generate, based on the input medical information, an item of the checklist, which is “checking a lump around an armpit near a left breast”. In yet another aspect, the user may acquire medical information, which is dense breasts, by asking the patient about one's condition. In this case, if the acquired medical information is input by the input 110 as a text, a voice, and a video, for example, the first checklist generator 121 may generate, based on the input medical information, an item of the checklist for consideration during a medical examination, which is “potential for dense breasts”.

In other words, the first checklist generator 121 may generate the item of the first checklist that conveys that a lump has been sensed around an armpit near a left breast of a patient or may generate the item of the first checklist that indicates that there is a potential for dense breasts according to the acquired medical information by input 110 which is based on asking the patient about one's condition.

The second checklist generator 122 may generate a second checklist according to the user's input.

For example, in a case in which the user selects the entire or some of the items of a default checklist, which are saved in the apparatus 100, the second checklist generator 220 may generate a second checklist that includes the items selected by the user.

In another aspect, the user may input regions or locations on the patient to be checked or examined, or lists to be considered during the medical examination, with a voice or a text. Accordingly, the second checklist generator 220 may generate a second checklist based on the user's input.

The checklist combiner 123 may generate a combined checklist by combining the first checklist and the second checklist. For example, in a case in which there is an item with overlapping content after comparing the first checklist and the second checklist, the checklist combiner 123 may combine the first checklist and the second checklist by selecting one of the two items according to the user's preset preference or a preset condition such as selecting an item which includes a more detailed description.

The item performance checker 130 may determine whether each of the items included in the checklist has been performed by analyzing a medical examination process on the patient.

In an aspect, the item performance confirmer 130 may analyze the medical examination process on the patient based on position information of a probe used in the medical examination, scanned information of the probe, voice information of the user and the patient, video information acquired by wearable devices that the user wears, and the user's behavior information acquired by an external camera, for example. The item performance confirmer 130 may then determine whether each of the items included in the checklist has been performed based on the analysis result.

For example, in a case in which the item performance confirmer 130 analyzes the position information of the probe and determines that the probe has remained for a certain time on a region or location where the tumor existed in the past, the item performance confirmer 130 may determine that the item for checking the past tumor has been performed.

In another aspect, in a case in which the item performance confirmer 130 analyzes and determines that the probe has repeatedly moved on a lump/painful region, the item performance confirmer 130 may determine that the item for checking the lump/painful region has been performed.

In another aspect, the item performance confirmer 130 may analyze a description (voice) about the lump/pain/area of past tumor, and may determine whether the item for checking the lump/pain/area of past tumor has been performed.

In another aspect, the item performance confirmer 130 may calculate a trace, where the probe has passed, by using the position information of the probe, and may determine whether breast scanning has been all performed based on the calculation result.

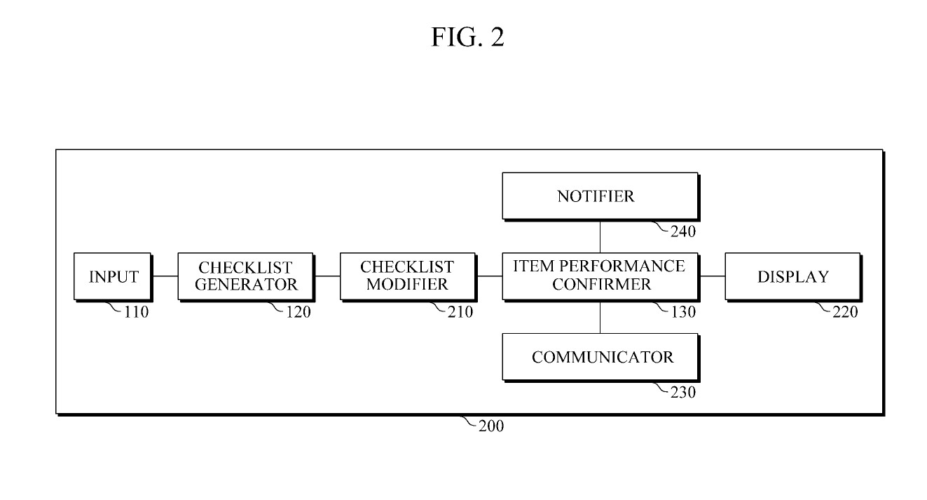

FIG. 2 is a diagram illustrating an apparatus for supporting a medical examination according to another aspect.

Referring to FIG. 2, an apparatus 200 for supporting the medical examination according to another aspect may further selectively include a checklist modifier 210, a display 220, a communicator 230, and a notifier 240.

The checklist modifier 210 may modify a personalized checklist, which has been generated by the checklist generator 120, according to the user's selection. For example, the checklist modifier 210 may perform deletion, addition, and modification, for example, of each of the items of the personalized checklist according to the user's selection.

The display 220 may output the generated checklist to a screen. For example, the display 220 may distinguish the first checklist from the second checklist and then output the first checklist and the second checklist to the screen. In another aspect, the display 220 may output, to the screen, a combined or personalized checklist, which has been generated after the first checklist and the second checklist are combined.

The display 220 may also display items of completed performance to be distinguished from uncompleted performance, according to a determination result of the item performance confirmer 130.

For example, the display 220 may display the items of completed performance to be distinguished from the items of uncompleted performance by marking the items of completed performance, changing the color or transparency of the items of completed performance, or deleting the items of completed performance from a list.

The communicator 230 may transmit the generated checklist and a determination result acquired by the item performance confirmer 130, to an external device that includes the display screen. In other words, the apparatus 200 may transmit the generated checklist and the determination result acquired by the item performance confirmer 130 to an external device through the communicator 230. The external device, which has received the generated checklist and the determination result, may then display, on the display screen, the received checklist and the received determination result.

The notifier 240 may provide a notification of the items of uncompleted performance to the user. Items of uncompleted performance may include items of the first checklist, the second checklist, or the combined checklist that have not been confirmed as being completed by the item performance confirmer 130.

In an aspect, the notifier 240 may provide a notification of the items of an uncompleted performance to the user through a video, a voice, and a vibration, for example. For example, the notifier 240 may provide the notification of the items of uncompleted performance to the user through blinking, changing a color or a letter size, or underlying, for example, on a checklist. In another aspect, the notifier 240 may provide the user with a notification window including the item of uncompleted performance. In yet another aspect, the notifier 240 may provide the user with a sound or vibration notification indicating that there are items of uncompleted performance.

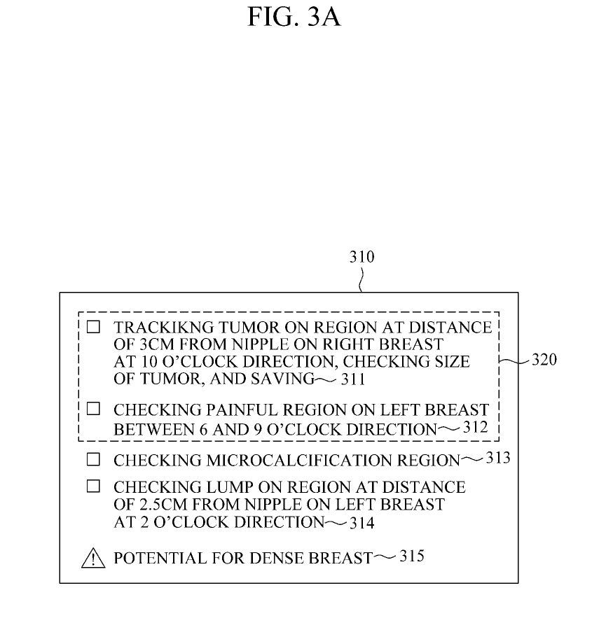

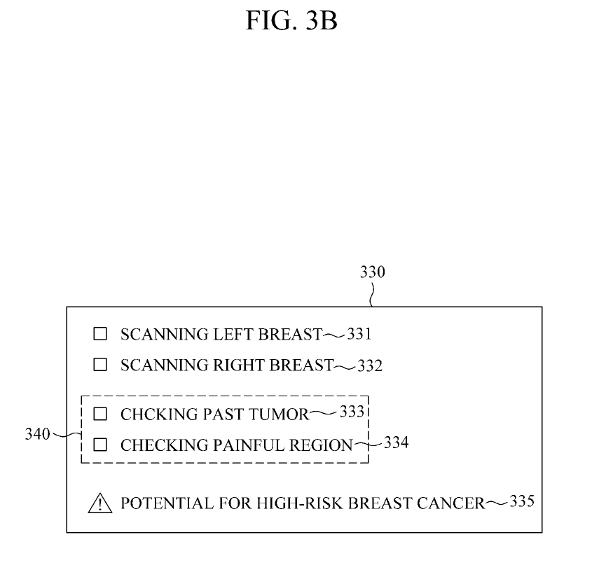

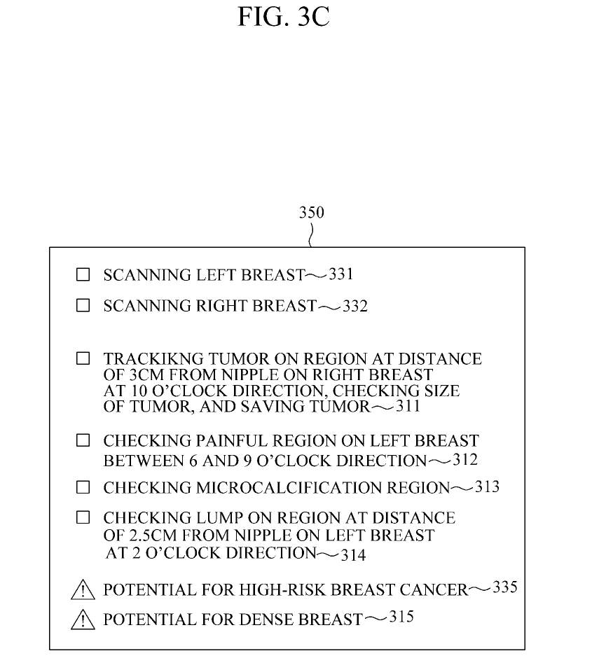

FIGS. 3A, 3B, and 3C are diagrams illustrating methods of combining the first checklist and the second checklist. Specifically, FIG. 3A is a diagram illustrating an example of the first checklist; FIG. 3B is a diagram illustrating an example of the second checklist; and FIG. 3C is a diagram illustrating an example of the combined checklist.

Referring to FIG. 3A, the first checklist generator 121 analyzes the patient's medical information to generate a first checklist 310. Illustrated in FIG. 3A, the first checklist 310 includes items 312 and 314 generated based on painful region information and lump region information, both of which are acquired by asking a patient about one's condition. The first checklist 310 also includes items 311 and 313 generated based on tumor region information and microcalcification region information, both of which are acquired through a past or previous examination record. Additionally, the first checklist 310 includes considerations for medical examination 315, which are generated based on information regarding dense breasts acquired by asking a patient about one's condition or through past examination record.

Referring to FIG. 3B, the second checklist generator 122 generates the second checklist 330 according to the user's input. As illustrated in FIG. 3B, the second checklist 330 includes default items 331 and 332 that the user selects, and items 333 and 334 that the user inputs. Also, the second checklist includes considerations for medical examination 335 that the user inputs.

Referring to FIG. 3C, the checklist combiner 123 combines the first checklist 310 and the second checklist 330. Referring to FIGS. 3A, 3B, and 3C, the items 320 of the first checklist 310 and items 340 of the second checklist 330 overlaps each other. Thus, the checklist combiner 123 combines the first checklist 310 and the second checklist 330 by selecting the item 320 which includes more specific descriptions between the items 320 and 340 overlapping each other.

As illustrated in FIG. 3C, a combined checklist 350 includes the items 311, 312, 313, and 314 and a consideration for medical examination 315 of the first checklist 310, and the items 331 and 332 and a consideration for medical examination 335 of the second checklist 330.

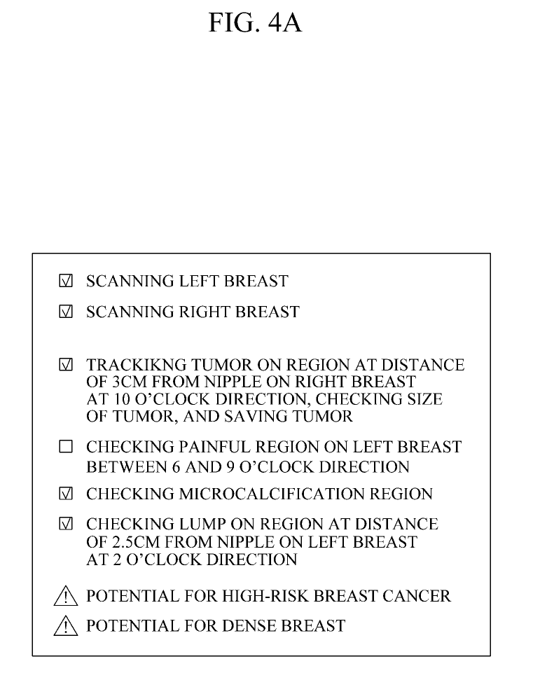

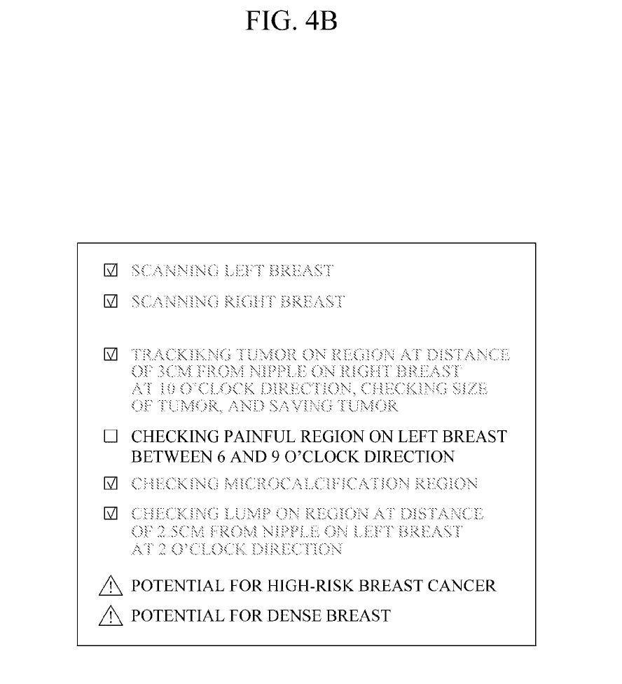

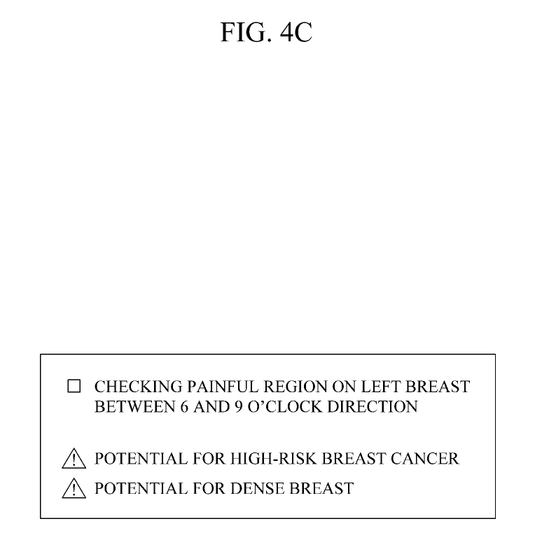

FIGS. 4A, 4B, and 4C are diagrams illustrating examples in which a display 220 displays items of completed performance to be distinguished from items of uncompleted performance according to a determination result of an item performance confirmer 130. Specifically, FIG. 4A is a diagram illustrating an example of marking items of completed performance; FIG. 4B is a diagram illustrating an example of changing colors of items of completed performance; and FIG. 4C is a diagram illustrating an example of deleting items of completed performance from a list.

Referring to FIG. 4A, the display 220 may mark the items of completed performance to be distinguished from items of uncompleted performance according to a determination result of the item performance confirmer 130.

Referring to FIG. 4B, the display 220 may change colors of the items of completed performance to be distinguished from the items of uncompleted performance according to a determination result of the item performance confirmer 130.

Referring to FIG. 4C, the display 220 may delete the items of completed performance to be distinguished from the items of uncompleted performance according to a determination result of the item performance confirmer 130.

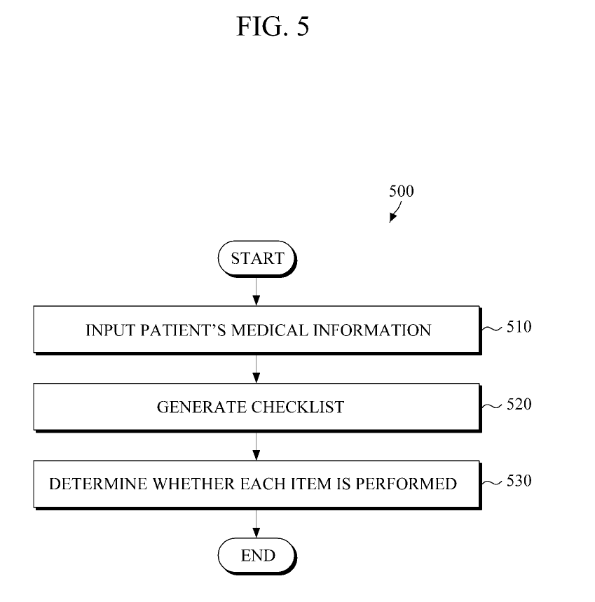

FIG. 5 is a flowchart illustrating a method of supporting the medical examination according to an aspect.

Referring to FIG. 5, a method 500 of supporting the medical examination according to an aspect first receives an input of medical information of the patient to be examined in 510. For example, apparatuses 100 and 200 illustrated in FIGS. 1 and 2 may receive an input of the patient's medical information in various forms, such as a text, a voice, and a video, for example.

Here, the medical information is information on the patient, which is referred to during the medical examination, and may include medical examination information by interview, which is acquired by asking the patient about one's condition, and a past or previous examination result, for example. Also, medical examination information by interview may include the information on a location of pain, a location of a touchable lump, the patient's age, whether the patient has dense breasts, a family history, history of surgeries, and history and current status of any diseases, for example. In addition, the past examination record is a record of various medical examinations performed in the past about the patient, and may include an X-ray examination record, a Breast Mammography examination record, a ultrasound examination record, a computed tomography (CT) examination record, a Magnetic Resonance Imaging (MRI) examination record, and a Positron Emission Tomography (PET) examination record, for example.

Then, the apparatus 100 or 200 generates the personalized checklist based on the input medical information of the patient in 520. Here, the checklist may include items to be performed or checked, and considerations for medical examination, for example, during the medical examination.

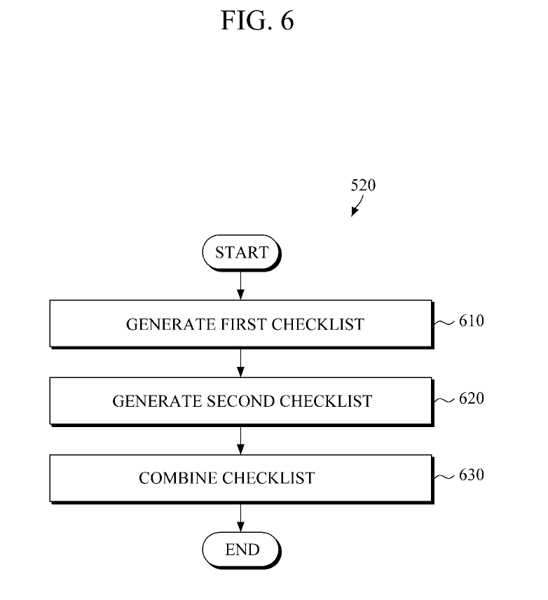

The operation 520 of generating the personalized checklist is specifically described later with reference to FIG. 6.

Then, the apparatus 100 or 200 determines whether each of the items included in the checklist has been performed by analyzing a medical examination process on a patient in 530. For example, the apparatus 100 or 200 may analyze the medical examination process on the patient based on position information of the probe used in the medical examination, scanned information of the probe, voice information of the user and the patient, video information acquired by wearable devices that the user wears, and the user's behavior information acquired by an external camera, for example, and may determine whether each of the items included in the checklist has been performed based on the analysis result.

FIG. 6 is a detailed flowchart illustrating an operation 520 of generating the personalized checklist of FIG. 5.

Referring to FIG. 6, in the operation 520, the apparatus 100 or 200 generates the first checklist by analyzing the patient's medical information which has been input first in 610. For example, the apparatus 100 or 200 may generate the first checklist by using a text mining technique, a voice recognizing technique, and a video recognizing technique, for example.

Then, the apparatus 100 or 200 generates the second checklist according to the user's input in 620. For example, the apparatus 100 or 200 may generate the second checklist based on the user's input in a case in which the user has selected the entire or some of the items of a default checklist saved in advance or has input a region to be checked or examined or considerations for medical examination.

Then, the apparatus 100 or 200 generates the combined checklist by combining the first checklist and the second checklist in 630. For example, in a case in which there is an item with overlapping content after comparing the first checklist and the second checklist, the apparatus 100 or 200 may combine the first checklist and the second checklist by selecting one of the two items according to the user's preset preference or a preset condition such as selecting an item which includes a more detailed description.

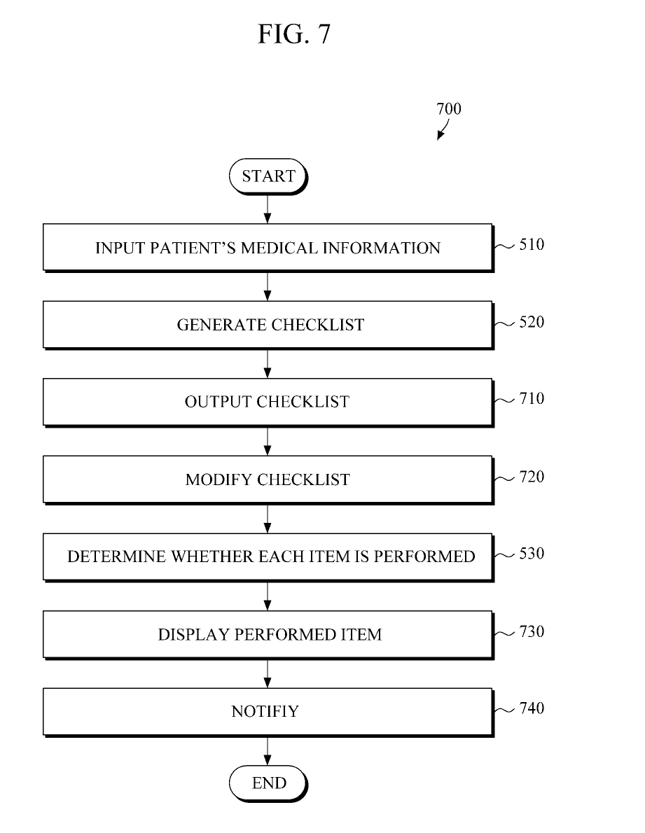

FIG. 7 is a flowchart illustrating a method of supporting the medical examination according to another aspect.

Referring to FIG. 7, a method 700 of supporting the medical examination may further selectively include, in FIG. 5, outputting a checklist in 710, modifying a checklist in 720, displaying a performed item in 730, and notifying in 740.

In 710, the generated checklist is output to a screen. For example, the apparatus 200 outputs the first checklist and the second checklist to be distinguished, or outputs, to the screen, the checklist generated by combining the first checklist and the second checklist.

In 720, the generated checklist is modified according to the user's selection. For example, the apparatus 200 may perform deletion, addition, and modification, for example, of each of the items of the personalized checklist according to the user's selection.

In 730, items of completed performance are displayed to be distinguished from items of uncompleted performance according to the determination result of 530. For example, the apparatus 200 may display the items of completed performance to be distinguished from the items of uncompleted performance by marking the items of completed performance, changing the color or transparency of the items of completed performance, or deleting the items of completed performance from a list.

In 740, a notification of items of uncompleted performance is provided to the user. For example, the apparatus 200 may a notification of the items of uncompleted performance to the user through a video, a voice, and a vibration, for example.

The apparatuses, units, modules, devices, and other components illustrated in FIGS. 1-7, for example, that may perform operations described herein with respect to FIGS. 1-7, for example, are implemented by hardware components. Examples of hardware components include controllers, sensors, memory, drivers, and any other electronic components known to one of ordinary skill in the art. In one example, the hardware components are implemented by one or more processing devices, or processors, or computers. A processing device, processor, or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processing device, processor, or computer includes, or is connected to, one or more memories storing instructions or software that are executed by the processing device, processor, or computer and that may control the processing device, processor, or computer to implement one or more methods described herein. Hardware components implemented by a processing device, processor, or computer execute instructions or software, such as an operating system (OS) and one or more software applications that run on the OS, to perform the operations described herein with respect to FIGS. 1-7, for example. The hardware components also access, manipulate, process, create, and store data in response to execution of the instructions or software. For simplicity, the singular term “processing device”, “processor”, or “computer” may be used in the description of the examples described herein, but in other examples multiple processing devices, processors, or computers are used, or a processing device, processor, or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, remote processing environments, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described herein may be performed by a processing device, processor, or a computer as described above executing instructions or software to perform the operations described herein.

Instructions or software to control a processing device, processor, or computer to implement the hardware components and perform the methods as described above may be written as computer programs, code segments, instructions or any combination thereof, for individually or collectively instructing or configuring the processing device, processor, or computer to operate as a machine or special-purpose computer to perform the operations performed by the hardware components and the methods as described above. In one example, the instructions or software include machine code that is directly executed by the processing device, processor, or computer, such as machine code produced by a compiler. In another example, the instructions or software include higher-level code that is executed by the processing device, processor, or computer using an interpreter. Based on the disclosure herein, and after an understanding of the same, programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processing device, processor, or computer to implement the hardware components, such as discussed in any of FIGS. 1-7, and perform the methods as described above in any of FIGS. 1-7, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processing device, processor, or computer so that the processing device, processor, or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processing device, processor, or computer.

What is claimed is:

1. An apparatus for supporting a medical examination, the apparatus comprising:
a checklist generator configured to generate a personalized checklist based on medical information; and
an item performance confirmer configured to determine whether each item included in the checklist is performed, by analyzing a medical examination process.

2. The apparatus of claim 1, wherein the checklist comprises items to be performed or checked, and considerations for medical examination.

3. The apparatus of claim 1, wherein the medical information comprises at least one of medical examination information by interview and a past examination record.

4. The apparatus of claim 1, wherein the checklist generator comprises:
a first checklist generator configured to generate a first checklist by analyzing the medical information;
a second checklist generator configured to generate a second checklist according to an input; and
a checklist combiner configured to combine the first checklist and the second checklist.

5. The apparatus of claim 1, further comprising:
an input configured to receive an input of the medical information in at least one form of a text, a voice, and a video.

6. The apparatus of claim 5, wherein the checklist generator is configured to generate the checklist by using at least one of a text mining technique, a voice recognizing technique, and a video recognizing technique according to the input medical information.

7. The apparatus of claim 1, wherein the item performance confirmer is configured to:
analyze a medical examination process based on at least one of position information of a probe used in a medical examination, scanned information of the probe, voice information, video information acquired by wearable devices, and behavior information acquired by an external camera; and
determine whether each of the items included in the checklist is performed.

8. The apparatus of claim 1, further comprising:
a checklist modifier configured to modify the checklist generated according to an input.

9. The apparatus of claim 1, further comprising:
a display configured to output the generated checklist to a screen, wherein the display is configured to, according to the determination result of the item performance confirmer, display items of completed performance to be distinguished from items of uncompleted performance.

10. The apparatus of claim 9, wherein the display is configured to display the items of completed performance to be distinguished from the items of uncompleted performance by marking the items of completed performance, changing a color or transparency of the items of completed performance, or deleting the items of completed performance from a list.

11. A method of supporting a medical examination, the method comprising:
generating a personalized checklist based on medical information; and
determining whether each item included in the checklist is performed, by analyzing a medical examination process.

12. The method of claim 11, wherein the checklist comprises items to be performed or checked, and considerations for medical examination.

13. The method of claim 11, wherein the medical information comprises at least one of medical examination information by interview and a past examination record.

14. The method of claim 11, wherein the generating of the checklist comprises:
generating a first checklist by analyzing the medical information;
generating a second checklist according to an input; and
combining the first checklist and the second checklist.

15. The method of claim 11, further comprising:
receiving an input of the medical information in at least one form of a text, a voice, and a video.

16. The method of claim 15, wherein the generating of the checklist comprises generating the checklist by using at least one of a text mining technique, a voice recognizing technique, and a video recognizing technique according to the input medical information.

17. The method of claim 11, wherein the determining of whether each of the items included in the checklist is performed comprises:
analyzing a medical examination process based on at least one of position information of a probe used in a medical examination, scanned information of the probe, voice information, video information acquired by wearable devices, and behavior information acquired by an external camera; and
determining whether each of the items included in the checklist is performed.

18. The method of claim 11, further comprising:
modifying the checklist generated according to an input.

19. The method of claim 11, further comprising:
displaying items of completed performance to be distinguished from items of uncompleted performance, according to the determination result of the determining of whether each of the items included in the checklist is performed.

20. The method of claim 19, the displaying of the items of completed performance to be distinguished from the items of uncompleted performance comprises displaying the items of completed performance to be distinguished from the items of uncompleted performance by marking the items of completed performance, changing a color or transparency of the items of completed performance, or deleting the items of completed performance from a list.
